(19) United States
(12) Patent Application Publication
(10) Pub. No.: US 2017/0113328 A1
(43) Pub. Date: Apr. 27, 2017

(54) Segmented Wood Bracing Assembly

(71) Applicant: Dale Alliger, West Valley City, UT (US)

(72) Inventor: Dale Alliger, West Valley City, UT (US)

(21) Appl. No.: 14/923,522

(22) Filed: Oct. 27, 2015

(51) Int. Cl. B25B 1/20; B25B 1/24

(52) U.S. Cl. CPC B25B 1/20; B25B 1/2489

(57) ABSTRACT

A segmented wood bracing assembly includes a base that has an upper surface a first lateral edge and a second lateral edge. A pair of rails is attached to the base and extends between the first and second lateral edges. Each of a plurality of cradles receives a plurality of wood sections to be glued together into a polygonal shape. The cradles include a receiver having a top side, a first side edge and a second side edge. The top side has a convexly arcuate section for receiving the wood sections. Each of the first and second side edges has one of a pair of clamps mounted thereon. A strap has a first end and a second end. Each of the first and second ends is removably engaged to one of the clamps. The clamps is actuated to locked position to tighten the strap over the top side.

### BACKGROUND OF THE DISCLOSURE

Field of the Disclosure

The disclosure relates to wood bracket devices and more particularly pertains to a new wood bracket device for securing a plurality of irregularly shaped wood sections together in a vice condition until the wood sections are secured together with glue.

### SUMMARY OF THE DISCLOSURE

An embodiment of the disclosure meets the needs presented above by generally comprising a base that has an upper surface. The base is elongated along a line extending between a first lateral edge and a second lateral edge. A pair of rails is attached to the base and extends between the first and second lateral edges. Each of a plurality of cradles receives a plurality of wood sections to be glued together into a polygonal shape. The cradles include a receiver slidably mounted on the rails and having an interior side, an exterior side, a top side, a bottom side, a first side edge and a second side edge. The top side has a convexly arcuate section such that the top side is substantially semi-cylindrical. Each of the first and second side edges has one of a pair of clamps mounted thereon. A strap has a first end and a second end. Each of the first and second ends is removably engaged to one of the clamps. The clamps is actuated to locked position to tighten the strap over the top side.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a segmented wood bracing assembly according to an embodiment of the disclosure.

FIG. 2 is a top perspective view of an embodiment of the disclosure.

FIG. 3 is a top view of an embodiment of the disclosure.

FIG. 4 is an end in-use view of an embodiment of the disclosure.

FIG. 5 is an end in-use view of an embodiment of the disclosure.

### DESCRIPTION OF THE PREFERRED EMBODIMENT

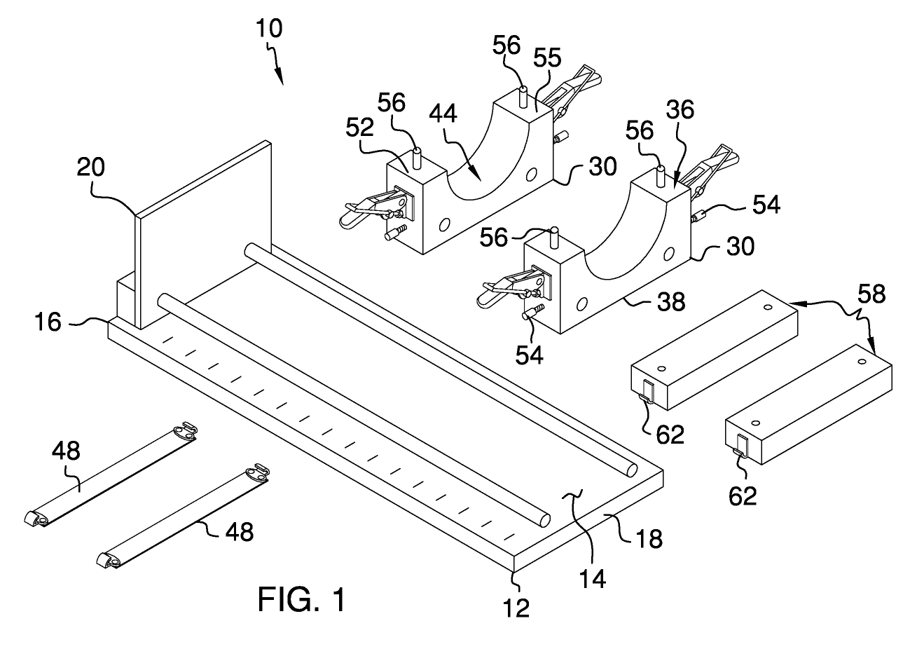

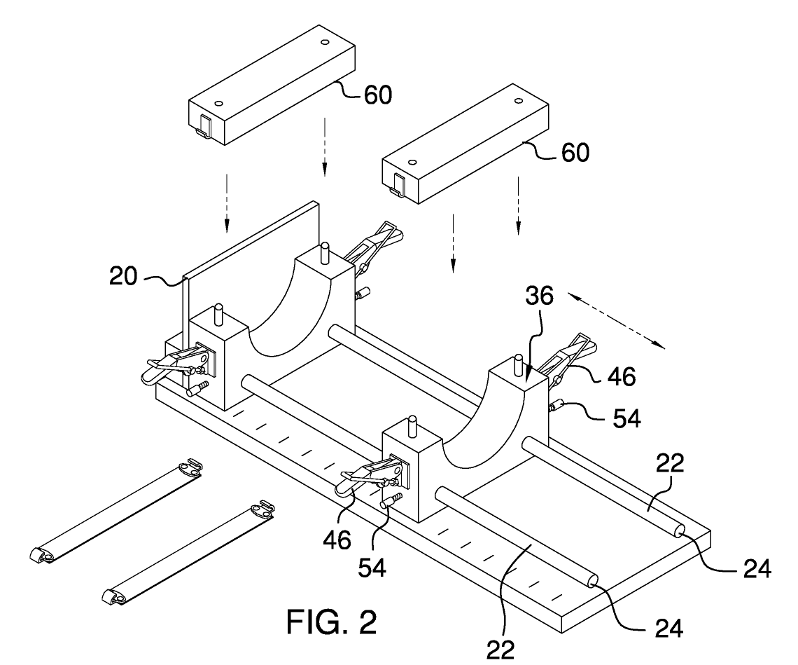

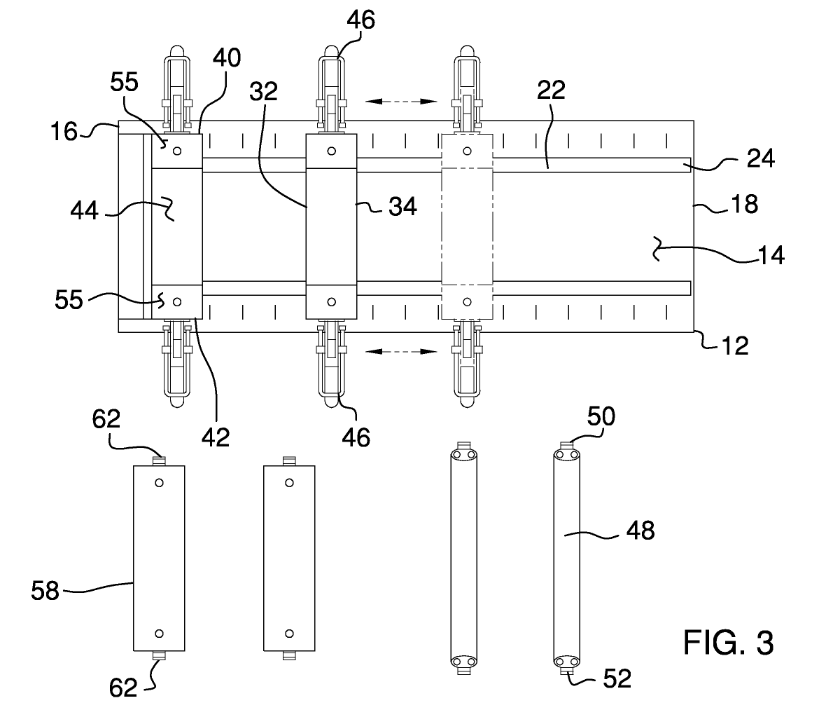

With reference now to the drawings, and in particular to FIGS. 1 through 5 thereof, a new wood bracket device embodying the principles and concepts of an embodiment of the disclosure and generally designated by the reference numeral 10 will be described.

As best illustrated in FIGS. 1 through 5, the segmented wood bracing assembly 10 generally comprises a base 12 that has an upper surface 14. The base 12 is elongated along a line extending between a first lateral edge 16 and a second lateral edge 18. A support wall 20 is attached to and extends upwardly from the upper surface 14. The support wall 20 is positioned adjacent to the first lateral edge 16. The upper surface 14 may include measurement indicia thereon and the base 12 has a length from the first lateral edge 16 to the second lateral edge 18 between 18.0 inches and 30.0 inches and a width between 8.0 inches and 14.0 inches.

A pair of rails 22 is attached to the support wall 20. The rails 22 extend toward the second lateral edge 18. Each of the rails 22 has a terminal end 24 positioned opposite of the support wall 20. The rails 22 are oriented parallel to each other and may be spaced from the upper surface 14.

A plurality of cradles 26 is provided. Each of the cradles 26 is configured to receive a plurality of non-squared wood sections 28 to be glued together in a polygonal shape. The wood sections 28 are cut in such a manner such that they may attached to each other, such as with wood glue, to form the polygonal shape as shown in FIG. 5. The support wall 20 may be used to abut each of the ends of the wood sections 28 such that they are evenly aligned along the support wall 20.

Each of the cradles 26 includes a receiver 30 having an interior side 32, an exterior side 34, a top side 36, a bottom side 38, a first side edge 40 and a second side edge 42. The receiver 30 is movably positioned on the rails 22 such that the internal side 32 faces the support wall 20. The top side 36 has a convexly arcuate section 44 such that the top side 36 is substantially semi-cylindrical. A pair of planar edges 55 is positioned on the top side 36 and is located on opposite sides of the convexly arcuate section 44. Each of the rails 22 extends through the interior side 32 and outwardly of the exterior side 34. A pair of clamps 46 is provided and each of the first 40 and second 42 side edges has one of the clamps 46 mounted thereon. A strap 48 has a first end 50 and a second end 52. Each of the first 50 and second 52 ends is removably engaged to one of the clamps 46 and the clamps 46 are actuated to locked position to tighten the strap 48 over the top side 36. As can be seen in FIG. 5, this will pull the strap 48 down against the wood sections 28 while glue positioned therebetween dries. A pair of locking members 54 is also provided. Each of the locking members 54 releasably engages one of the rails 22 to retain the receiver 30 at a selected position on the rails 22. The locking members 54 may include threaded members extending through the receiver 30 and being abuttable against the rails 22.

Each cradle 26 may include a pair of mounts 56 that is attached to the receiver 30 and extending upwardly therefrom. Each of the planar edges 55 has one of the mounts 56 positioned thereon. The mounts 56 may comprise posts. A top brace 58 is positionable on the top side 36 and extends over convexly arcuate section 44. The top brace 58 has a lower surface 60 that may be planar. The lower surface 60 releasably engages the mounts 56 and the top brace 58 includes a pair of catches 62. Each of the clamps 46 is engageable with one of the catches 62 to urge the top brace 58 towards the top side 36 when the clamps 46 are not engaged with the strap 48. Thus only one of the strap 48 or the top brace 58 is engageable with the receiver 30 at a time.

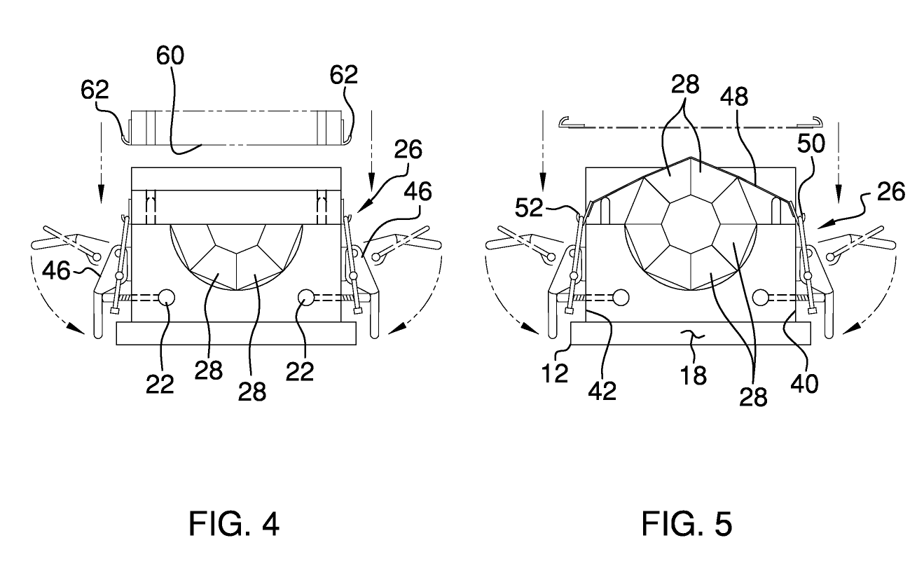

In use, the cradles 26 may be used with the top braces 58 to support a half-formed assembly of wood sections 28 as shown in FIG. 4. The top braces 58 abut the wood sections 28 until they are secured together with the wood glue. The half-formed sections are then mounted together as shown in FIG. 5 and glued and secured in place until dry. The strap 48 is used to ensure a tight fit between all wood sections 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A segmented wood clamping assembly comprising:
a base having an upper surface, said base being elongated along a line extending between a first lateral edge and a second lateral edge;
a pair of rails being attached to said base and extending between said first and second lateral edges;
a plurality of cradles, each of said cradles being configured to receive a plurality of wood sections to be glued together in a polygonal shape, each of said cradles including:
a receiver slidably mounted on said rails and having an interior side, an exterior side, a top side, a bottom side, a first side edge and a second side edge, said top side having a convexly arcuate section such that said top side is substantially semi-cylindrical;
a pair of clamps, each of said first and second side edges having one of said clamps mounted thereon; and
a strap having a first end and a second end, each of said first and second ends being removably engaged to one of said clamps, said clamps being actuated to locked position to tighten said strap over said top side.

2. The segmented wood clamping assembly according to claim 1, wherein a support wall is attached to and extends upwardly from said upper surface, said support wall being positioned adjacent to said first lateral edge, said pair of rails being attached to said support wall, each of said rails having a terminal end positioned opposite of said support wall, said rails being oriented parallel to each other, said rails being spaced from said upper surface.

3. The segmented wood clamping assembly according to claim 2, wherein aid internal side faces said support wall, said top side having a convexly arcuate section such that said top side is substantially semi-cylindrical, each of said rails extending through said interior side and outwardly of said exterior side.

4. The segmented wood clamping assembly according to claim 1, wherein said cradle further includes:
a pair of planar edges being positioned on said top side and being located on opposite sides of said convexly arcuate section;
a pair of mounts being attached to said receiver and extending upwardly therefrom, each of said planar edges having one of said mounts positioned thereon; and
a top brace being positionable on said top side and extending over convexly arcuate section, said top brace having a lower surface being planar, said lower surface releasably engaging said mounts.

5. The segmented wood clamping assembly according to claim 4, wherein said top brace has a pair of catches, each of said clamps being engageable with one of said catches to urge said top brace towards said top side, wherein only one of said strap or said top brace is engaged with said receiver.

6. The segmented wood clamping assembly according to claim 1, further including a pair of locking members, each of said locking members releasably engaging one of said rails to retain said receiver at a selected position on said rails.

7. A segmented wood clamping assembly comprising:
a base having an upper surface, said base being elongated along a line extending between a first lateral edge and a second lateral edge, a support wall being attached to and extending upwardly from said upper surface, said support wall being positioned adjacent to said first lateral edge;
a pair of rails being attached to said support wall, said rails extending toward said second lateral edge, each of said rails having a terminal end positioned opposite of said support wall, said rails being oriented parallel to each other, said rails being spaced from said upper surface;
a plurality of cradles, each of said cradles being configured to receive a plurality of wood sections to be glued together in a polygonal shape, each of said cradles including:
a receiver having an interior side, an exterior side, a top side, a bottom side, a first side edge and a second side edge, said receiver being movably positioned on said rails such that said internal side faces said support wall, said top side having a convexly arcuate section such that said top side is substantially semi-cylindrical, a pair of planar edges being positioned on said top side and being located on opposite sides of said convexly arcuate section, each of said rails extending through said interior side and outwardly of said exterior side;
a pair of clamps, each of said first and second side edges having one of said clamps mounted thereon;
a pair of locking members, each of said locking members releasably engaging one of said rails to retain said receiver at a selected position on said rails;
a pair of mounts being attached to said receiver and extending upwardly therefrom, each of said planar edges having one of said mounts positioned thereon;
a top brace being positionable on said top side and extending over convexly arcuate section, said top brace having a lower surface being planar, said lower surface releasably engaging said mounts, said top brace having a pair of catches, each of said clamps being engageable with one of said catches to urge said top brace towards said top side;
a strap having a first end and a second end, each of said first and second ends being removably engaged to one of said clamps, said clamps being actuated to locked position to tighten said strap over said top side; and
wherein only one of said strap or said top brace is engaged with said receiver.
